(19) United States
(12) Patent Application Publication
(10) Pub. No.: US 2026/0288505 A1
(43) Pub. Date: Sep. 24, 2026

(54) LIFT-AND-SHIFT STRATEGY FOR CONTAINERS IN CONFIDENTIAL COMPUTING ENVIRONMENTS

(71) Applicant: NVIDIA Corporation, Santa Clara, CA (US)

(72) Inventor: Marko Zvonko KAISER, Glowe (DE)

(73) Assignee: NVIDIA Corporation, Santa Clara, CA (US)

(21) Appl. No.: 19/086,769

(22) Filed: Mar. 21, 2025

(51) Int. Cl. G06F 9/455

(52) U.S. Cl. CPC G06F 9/45558; G06F 2009/45562; G06F 2009/45579; G06F 2009/45587

(57) ABSTRACT

In various examples, systems and methods are disclosed relating to managing confidential containers implementing graphics processing unit (GPU) workloads are disclosed. A system can initialize a virtual machine corresponding to a confidential computing environment. The system can generate a mapping for at least one physical component interface to the virtual machine. The system can update a configuration setting(s) of a container to be executed within the virtual machine based on the mapping and a container-device interface (CDI). The system can execute the container within the confidential computing environment of the virtual machine according to the configuration setting(s).

### BACKGROUND

Containers can provide a lightweight and efficient method for packaging and deploying applications in a manner that enables consistent operation across various environments. Confidential computing can be implemented using encryption techniques to protect data at the hardware level. However, implementing containers with confidential computing is challenging.

### SUMMARY

The present disclosure relates to systems and methods for implementing confidential containers with graphics processing units (GPUs) using a lift-and-shift strategy. Containerization enables consistent execution across different computing platforms by encapsulating application code, libraries, configuration settings, and runtime environments. However, deploying containerized workloads in secure environments, particularly with GPU workloads, presents challenges. Confidential Computing protects sensitive data during processing using hardware-based Trusted Execution Environments (TEEs). Conventional approaches require significant modifications to container applications and container settings to operate within TEEs. Conventional container runtimes cannot effectively support GPU workloads due to resource management and device pass-through limitations.

To address these challenges, the techniques described herein implement a lift-and-shift strategy for confidential containers executing GPU workloads. The techniques described herein integrate containers within secure environments while supporting efficient resource management among Peripheral Component Interconnect Express (PCIe) devices without manual configuration. To do so, the PCIe topology of a host can be automatically mapped to guest environments in virtual machines (VMs) using Virtual Function I/O (VFIO) devices and Container Device Interfaces (CDI). An attestation process can be used to verify the security and integrity of the environment before executing containerized workloads, operating transparently to the container. These techniques can be applied to various host system environments and container workloads, including systems executing multiple containers sharing a single GPU by leveraging virtualization features such as virtual GPUs (vGPUs) or Multi-Instance GPU (MIG) partitions.

At least one aspect relates to one or more processors. The one or more processors can include one or more circuits. The one or more circuits can initialize a virtual machine corresponding to a confidential computing environment. The one or more circuits can generate a mapping for at least one physical component interface (e.g., PCIe interface) to the virtual machine. The one or more circuits can update at least one configuration setting of a container to be executed within the virtual machine based at least on the mapping and a container-device interface (CDI). The one or more circuits can execute the container within (e.g., using GPU(s) within) the confidential computing environment of the virtual machine according to the at least one configuration setting.

In some implementations, the physical component interface is a PCIe interface. In some implementations, the one or more circuits can initialize at least one VFIO device within the virtual machine corresponding to the physical component interface. In some implementations, the one or more circuits can initiate a container runtime (e.g., Kata runtime) within the virtual machine to update the at least one configuration setting. In some implementations, the one or more circuits can execute the container using the container runtime. In some implementations, the one or more circuits can identify a plurality of GPUs having a plurality of identifiers (e.g., BFD addresses). In some implementations, the one or more circuits can update the at least one configuration setting based on the plurality of GPUs. In some implementations, the one or more circuits can determine, using an attestation function, that the virtual machine is operating within the confidential computing environment. In some implementations, the one or more circuits can execute the container responsive to determining that the virtual machine is operating within the confidential computing environment. In some implementations, the one or more circuits can encrypt at least one region of memory corresponding to the virtual machine. In some implementations, the one or more circuits can generate, using the attestation function, an attestation message for the virtual machine. In some implementations, the one or more circuits can transmit the attestation message to at least one verification system. In some implementations, the container is one of a plurality of containers, and the one or more processors can execute the plurality of containers each accessing a respective hardware device (e.g., PCIe device) of a plurality of hardware devices according to the CDI. In some implementations, the one or more circuits can initialize at least one GPU coupled to the at least one physical component interface using a driver stack within the virtual machine.

At least one aspect relates to a system. The system can include one or more processors. The system can generate, during initialization of a virtual machine, a value representative of the state of the virtual machine. The system can determine, using an agent executing within the virtual machine and the value, that the virtual machine is executing within a confidential computing environment. The system can update at least one configuration setting of a container to be executed within the virtual machine based at least on a container-device interface (CDI) in response to determining that the virtual machine is executing within the confidential computing environment. The system can execute the container within the confidential computing environment of the virtual machine according to the at least one configuration setting.

In some implementations, the system can initialize the virtual machine within using a confidential computing signal of the one or more processors. In some implementations, the system can encrypt at least one region of memory corresponding to the virtual machine. In some implementations, the system can generate an attestation message based at least on the encryption of the at least one region of memory. In some implementations, the system can transmit the attestation message to a verification system. In some implementations, the system can determine that the virtual machine is executing within the confidential computing environment based at least on receiving a verification message from the verification system in response to the attestation message. In some implementations, the system can generate a mapping for at least one physical component interface to the virtual machine. In some implementations, the system can update the at least one configuration setting of the container based at least on the mapping.

At least one aspect is related to a method. The method can include initializing, using one or more processors, a virtual machine corresponding to a confidential computing environment. The method can include generating, using the one or more processors, a mapping for at least one physical component interface to the virtual machine. The method can include updating, using the one or more processors, at least one configuration setting of a container to be executed within the virtual machine based on the mapping and a CDI. The method can include executing, using the one or more processors, the container within the confidential computing environment of the virtual machine according to the at least one configuration setting.

In some implementations, the physical component interface is a PCIe interface. In some implementations, the method can include initializing, using the one or more processors, at least one VFIO device within the virtual machine corresponding to the physical component interface. In some implementations, the method can include initiating, using the one or more processors, a container runtime within the virtual machine to update the at least one configuration setting. In some implementations, the method can include executing, using the one or more processors, the container using the container runtime.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a multi-modal language model, a system for performing generative AI operations using a small language model, a system for performing generative AI operations using a large language model, a system for performing generative AI operations using a vision language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for managing confidential containers implementing graphics processing unit (GPU) workloads are described in detail below with reference to the attached drawing figures, wherein:

FIG. 1 is a block diagram of an example system for managing confidential containers implementing GPU workloads, in accordance with some embodiments of the present disclosure;

FIG. 2 depicts a block diagram showing an example hierarchy implementing runtimes and virtual machines according to the techniques described herein, in accordance with some embodiments of the present disclosure;

FIGS. 3A and 3B show data flow diagrams illustrating an example initialization process for one or more containers implementing the techniques described herein, in accordance with some embodiments of the present disclosure;

FIG. 4 is a flow diagram of an example method for managing confidential containers implementing GPU workloads, in accordance with some embodiments of the present disclosure;

FIG. 5 is a block diagram of an example computing device suitable for use in implementing at least some embodiments of the present disclosure; and

FIG. 6 is a block diagram of an example data center suitable for use in implementing at least some embodiments of the present disclosure.

### DETAILED DESCRIPTION

The present disclosure relates to systems and methods for implementing confidential containers in connection with graphics processing units (GPUs) using a lift-and-shift strategy. Containerization has emerged as an approach for deploying applications in lightweight and portable environments, enabling consistent execution across different computing platforms. Containers can encapsulate application code, libraries, configuration settings, and runtime environments, which can be deployed on various infrastructure without requiring additional dependencies or configuration. However, challenges arise when deploying containerized workloads in secure environments, particularly when attempting to deploy and use containers implementing GPU workloads.

Confidential Computing is a security model that protects sensitive data while it is in use (e.g., during processing), using hardware-based Trusted Execution Environments (TEEs). Conventional approaches to confidential computing with containers often require significant modifications to applications and configuration settings of the container to operate within TEEs. Additionally, such approaches, which focus on process-based isolation, cannot effectively support GPU workloads due to limitations in resource management and device pass-through.

To address these challenges, the techniques described herein can implement a lift-and-shift strategy for confidential containers for executing GPU workloads. Platforms implementing these techniques can integrate containers within secure environments while supporting efficient resource management among PCIe devices without requiring manual configuration. To do so, the techniques described herein can automatically map the PCIe topology of a host to one or more guest environments, which may be executing in one or more virtual machines (VMs). The mapping of PCIe topology can be achieved through the use of one or more Virtual Function I/O (VFIO) devices and one or more Container Device Interfaces (CDI) to handle device pass-through and topology replication among containers executing within the guest environment.

To implement confidential computing, the techniques described herein can implement an attestation process to verify the security and integrity of the environment before executing containerized workloads. The attestation process can operate transparently to the container, such that containers deployed within attested environments can operate according to the requirements of confidential computing without requiring modification or manual configuration, for example, using a lift-and-shift strategy. The techniques described herein can be applied to a variety of host system environments and container workloads, including systems executing multiple containers sharing a single GPU by leveraging virtualization features such as virtual GPUs (vGPUs) or Multi-Instance GPU (MIG) partitions.

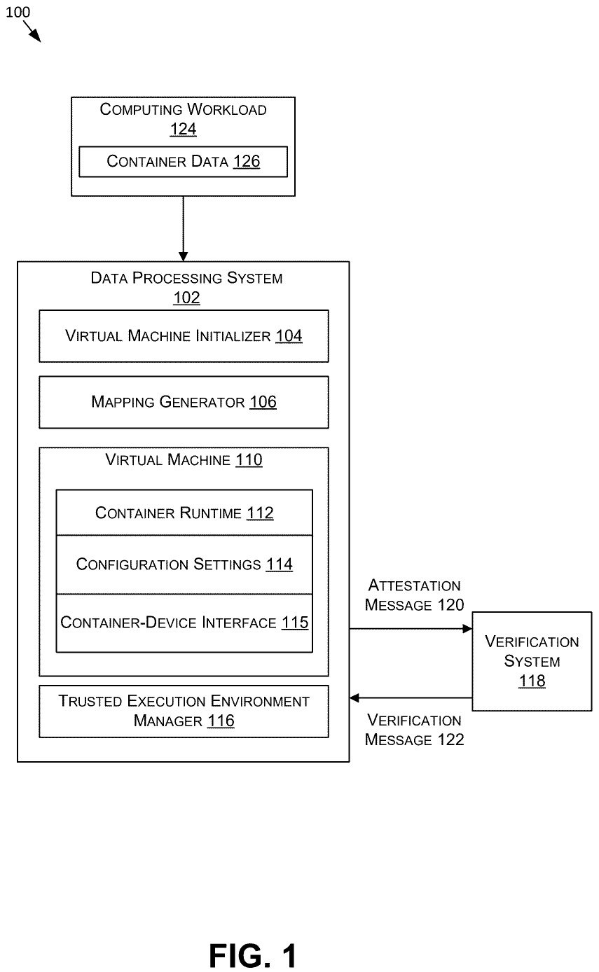

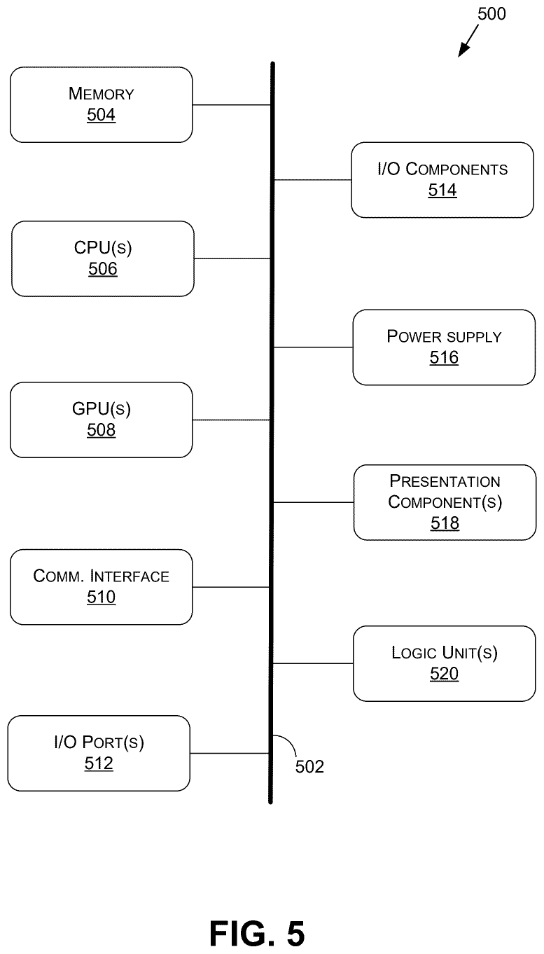

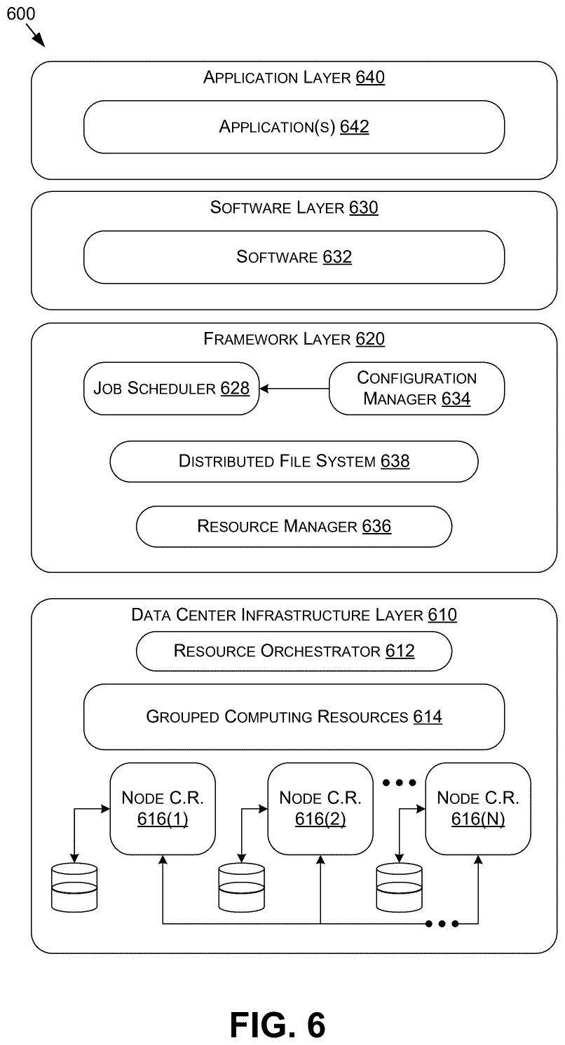

With reference to FIG. 1, FIG. 1 is an example computing environment including a system 100 for managing confidential containers implementing GPU workloads, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more computing devices or components thereof (e.g., as described in FIG. 5), and/or one or more data centers or components thereof (e.g., as described in FIG. 6).

The system 100 can be used to manage confidential containers implementing GPU workloads according to the techniques described herein. The system is shown as including a data processing system 102. The data processing system 102 is shown as including a virtual machine initializer 104, a mapping generator 106, and a virtual machine 110. The virtual machine 110 can include a container runtime 112, configuration settings 114, and/or a container-device interface 115. In some implementations, the configuration settings 114 may be internal or external to the virtual machine 110, or partially internal and/or partially external to the virtual machine 110. The system 100 is shown as including a trusted execution environment manager 116, which as described in further detail herein may manage the execution of the virtual machine 110 within a trusted environment via communications with a verification system 118. The system 100 is shown as including a computing workload(s) (e.g., GPU workload(s)) 124, which in this example is shown as including container data 126.

The data processing system 102 can include one or more processors, circuits, memory, and/or computing devices/systems that can perform the various techniques described herein. The data processing system 102 can be used to execute GPU workloads 124 in containers within one or more virtual machines 110, which operate within a confidential computing environment (sometimes referred to here as a “trusted execution environment (TEE)”). The data processing system 102 may operate as part of a data center, a cloud computing system, a distributed computing system, one or more servers, or a personal computing system, among others. The data processing system 102 can receive one or more GPU workloads 124 from one or more external computing systems, applications, or data sources. In some implementations, the data processing system 102 can execute one or more of the operations described herein in response to one or more corresponding application programming interface (API) requests.

The GPU workloads 124 can include various instructions, such as computational tasks, data processing operations, or other data. In some implementations, a GPU workload 124 can be received by the data processing system 102 from external computing systems, applications, or data sources. In some implementations, the data processing system 102 can parse the received GPU workloads 124 to identify specific tasks or operations to be executed within one or more containers. The parsing process can involve extracting relevant information from one or more data structures making up the workload, such as configuration settings, resource requirements, and/or execution parameters. The data processing system 102 can then allocate the necessary resources, as described in further detail herein, to execute the parsed GPU workloads 124 within the containers.

The container data 126 can include various types of content, such as confidential or protected data, encrypted data that is only to be accessed upon attestation of the confidential computing environment, and/or other information for executing the one or more containers. In some implementations, the data processing system 102 or components thereof can decrypt and execute the GPU workload 124 and/or container data 126 within one or more containers according to the techniques described herein. For example, the container data 126 may include encrypted machine learning models that are only accessible (e.g., decrypted) after the attestation process verifies the security and integrity of the environment. In some implementations, the container data 126 can include configuration settings, input data, or additional metadata that can be used when executing the GPU workloads 124. For example, in some implementations, the container data 126 of the GPU workload 124 can specify the types of hardware requirements, such as memory, specific hardware devices like GPUs, and other resources needed to execute the GPU workload 124. The data processing system 102 or the components thereof can perform the various techniques described herein to ensure that any GPU workload 124 is securely executed within a confidential computing environment.

The virtual machine initializer 104 can initialize a virtual machine 110 corresponding to a confidential computing environment. The virtual machine initializer 104 can include various components, such as initialization scripts, configuration files, and executable binaries, and/or hardware, among others. The virtual machine 110 can be a lightweight virtual machine designed to run containerized workloads efficiently within a confidential computing environment. For example, the virtual machine 110 can be or include a minimalistic container runtime virtual machine. Initializing the virtual machine 110 can include loading one or more virtual machine images from memory of the data processing system 102, allocating various hardware resources (e.g., CPU, memory, storage, additional devices as described in further detail herein), and/or initializing one or more trusted execution circuits of the data processing system 102 (e.g., the trusted execution environment manager 116). In some implementations, initializing the virtual machine 110 can include encrypting one or more regions of memory of the data processing system 102, as described in further detail herein in connection with the trusted execution environment manager 116. The regions of memory can be encrypted such that host processes cannot access any of the information relating to the guest environment of the virtual machine 110.

In some implementations, the trusted execution environment manager 116 can encrypt at least one region of memory of the data processing system 102 corresponding to the virtual machine 110. The trusted execution environment manager 116 can include hardware, software, or combinations thereof, in some implementations. To perform encryption (e.g., initiate or configure encryption to occur, etc.), the trusted execution environment manager 116 can access one or more TEE hardware or hypervisor capabilities of the processor(s) of the data processing system 102 to encrypt the memory for the virtual machine 110. For example, the trusted execution environment manager 116 can access TEE-specific registers, memory addresses, or commands, including but not limited to such as Secure Encrypted Virtualization (SEV) or Intel Software Guard Extensions (SGX) to enable hardware-level encryption. Processor flags or other hardware flags can be set to indicate that one or more memory regions should be encrypted. The flags can be set during the initialization of the virtual machine 110 such that the memory regions corresponding to the virtual machine 110 are encrypted at the host.

In some implementations, the trusted execution environment manager 116 and/or the virtual machine initializer 104 can map pages of memory corresponding to the virtual machine 110 such that the processor(s) can encrypt the memory regions using hardware-level encryption. Doing so can include marking or flagging pages as encrypted and may indicate identifiers of corresponding encryption keys and/or virtual machines 110 to which the pages correspond. In some implementations, the trusted execution environment manager 116 and/or the virtual machine initializer 104 can provide or initialize encrypted firmware within the hypervisor for the virtual machine 110. The encrypted firmware can be loaded into the encrypted region(s) of memory.

In some implementations, the trusted execution environment manager 116 can generate, cause generation of, and/or access encryption keys for encrypting the memory regions corresponding to the virtual machine 110 using hardware-based key management features provided by the processor(s) of the data processing system 102. For example, the trusted execution environment manager 116 can use one or more Secure Key Management (SKM) circuits, Key Management Enclave (KME) circuits, or other key generation/management circuits of the processor(s) of the data processing system 102 to generate and/or manage encryption/decryption keys. Any suitable cryptographic algorithm can be used to generate the encryption/decryption keys, including but not limited to the AES-256 algorithm.

Encryption and decryption processes performed for the confidential computing environment can be transparent to the guest environment of the virtual machine 110. The encryption and decryption keys, generation of which may be initiated/coordinated/performed by the trusted execution environment manager 116, can be automatically used by one or more memory controllers of the processor(s) of the data processing system 102 to encrypt and decrypt data in real-time. For example, when the virtual machine 110 (or components executing therein) write to memory of the data processing system (e.g., random access memory (RAM), etc.), the processor(s) can automatically encrypt the written data before the written data is transferred from the processor caches to a memory bus. Furthering this example, when the virtual machine 110 (or components executing therein) access any encrypted memory regions, the processor(s) can decrypt the accessed data on-the-fly in the memory controller (e.g., when reading to processor caches) using corresponding decryption keys. In doing so, the guest environment executing in the virtual machine 110 can read and write data as if the data were unencrypted. The encryption and decryption keys used for the memory corresponding to the virtual machine 110 can be keyed/identified with an identifier of the virtual machine 110.

The virtual machine initializer 104 can initialize the virtual machine 110 such that the virtual machine 110 can access one or more hardware components of the data processing system. In some implementations, the hardware components may be represented as devices or virtual devices. The hardware components may include any type of device that is visible or accessible by an operating system or other software, including but not limited to PCIe devices, PCI devices, input/output interfaces, or any other component. In some implementations, the hardware components may include one or more GPUs accessible via one or more physical component interfaces (e.g., PCIe interfaces). The virtual machine 110 can be initialized using a mapping for the physical component interfaces of the data processing system 102.

To generate the mapping, the data processing system 102 can execute the mapping generator 106 to generate the mapping for at least one physical component interface to the virtual machine 110. The mapping generator 106 can include hardware, software, or combinations thereof. The mapping generator 106 can initialize one or more physical component interfaces to virtual resources, such as VFIO devices. This can be performed by identifying the physical component interfaces of the data processing system 102 (e.g., using corresponding operating system calls, etc.) and generating corresponding virtual resources that replicate the functionality of these interfaces. For example, the mapping generator 106 can map a physical PCIe device to a VFIO device, which can then be provided to the virtual machine 110 during initialization.

The mapping generator 106 can generate the mapping for physical component interfaces to virtual resources by configuring any corresponding parameters or settings within the host environment of the data processing system 102 to facilitate the mapping of physical resources to virtual devices. This can include initializing the VFIO devices to be used for device pass-through for virtual environments (e.g., the virtual machine 110). In some implementations, all of the PCIe can be replicated within the virtual machine 110 as VFIOs, such that the virtual machine 110 can access the virtual resources as if they were physical components. The mapping generator 106 and/or the virtual machine initializer 104 can provide settings for initializing the virtual machine 110 to identify and enumerate specific virtual resources for corresponding physical components (e.g., GPUs, etc.) during initialization.

In some implementations, the mapping generator 106 can initialize additional virtual resources, such as virtual network interfaces or storage devices, such that they can be accessible by the virtual machine 110. For example, the mapping generator 106 can create a virtual network interface that replicates the functionality of a physical network interface, allowing the virtual machine 110 to communicate with other virtual machines or external systems. In some implementations, the mapping generator 106 can create a virtual storage device that replicates the functionality of a physical storage device, such that the virtual machine 110 can access and can store data as if it were using a physical device. Any number of virtual devices or components can be mapped to corresponding devices within the virtual machine 110. In some implementations, the topology of PCIe devices of a PCIe switch can be replicated within the virtual machine 110, to facilitate peer-to-peer communication or other communication functionalities between PCIe devices within the virtual machine. In some implementations, the topology of PCIe devices can be replicated as a flat topology within the virtual machine 110. In such implementations, configuration settings (as described in further detail herein) can be provided to specify various functionalities or capabilities of PCIe devices to enable peer-to-peer communication or other types of communication within the virtual machine 110 that would otherwise be possible in the host environment.

In some implementations, the virtual machine initializer 104 can initialize at least one GPU coupled to the at least one physical component interface using a driver stack within the virtual machine 110. To do so, the virtual machine initializer 104 can provide, load, or otherwise specify the GPU driver stack to the virtual machine 110. In some implementations, this can involve copying the necessary driver files and configuration settings into a file system of the virtual machine 110 and/or updating the configuration of the virtual machine 110 to identify the GPU. In some implementations, the virtual machine initializer 104 can provide one or more initialization scripts, commands, or binaries as part of the virtual machine image, which cause the virtual machine 110 to initialize the driver stack into the operating system guest environment. Once the driver stack is loaded, the virtual machine 110 can configure the GPU for use by other components of the virtual machine 110 by initializing the GPU according to one or more initialization procedures. This can include allocating memory and compute resources to the GPU or otherwise communicating with the GPU via one or more VFIO devices to perform initialization operations.

Other devices mapped to the virtual machine 110 using the mapping generator 106 can be initialized using similar operations. In some implementations, the guest operating system of the virtual machine 110 and/or drivers of the various virtual devices may capture device information for use in generating an attestation message. In some implementations, physical devices, such as GPUs, can be enumerated and ordered via the driver stack according to their Bus-Device-Function (BDF) addresses (or identifiers). For example, the driver stack of the virtual machine 110 can enumerate BDF identifiers corresponding to the physical component interfaces of the host system, and the virtual machine initializer 104 can map these BDF identifiers to virtual devices within the virtual machine 110, as described in further detail herein.

Once the physical component interface topology is mapped to the virtual machine 110 using one or more virtual devices, the virtual machine initializer 104 can initiate the container runtime 112 within the virtual machine 110. The container runtime 112 can be implemented using software, hardware, or a combination thereof. The container runtime 112 can be used to manage the lifecycle of containers within the virtual machine 110. The container runtime 112 can orchestrate the execution of containerized applications by handling tasks such as starting, stopping, and monitoring containers. The container runtime 112 can allocate system and hardware resources of the virtual machine 110 for each container, including allocating specific GPUs to one or more containers (e.g., to execute one or more GPU workloads 124 including container data 126).

The container runtime 112 can update configuration settings 114 of a container to be executed within the virtual machine 110 based on the mapping and a container-device interface 115. The process of updating configuration settings 114 for containers can involve mapping one or more virtual devices to the container using the container-device interface 115. The container-device interface 115 can facilitate the identification and enumeration of virtual devices, such as virtual GPUs or other virtual hardware components, which may be required for the container to execute the GPU workload 124. The container runtime 112 can access the container-device interface 115 to update corresponding configuration settings 114 of a container to be executed to map corresponding GPU devices or other physical component interfaces to the corresponding container.

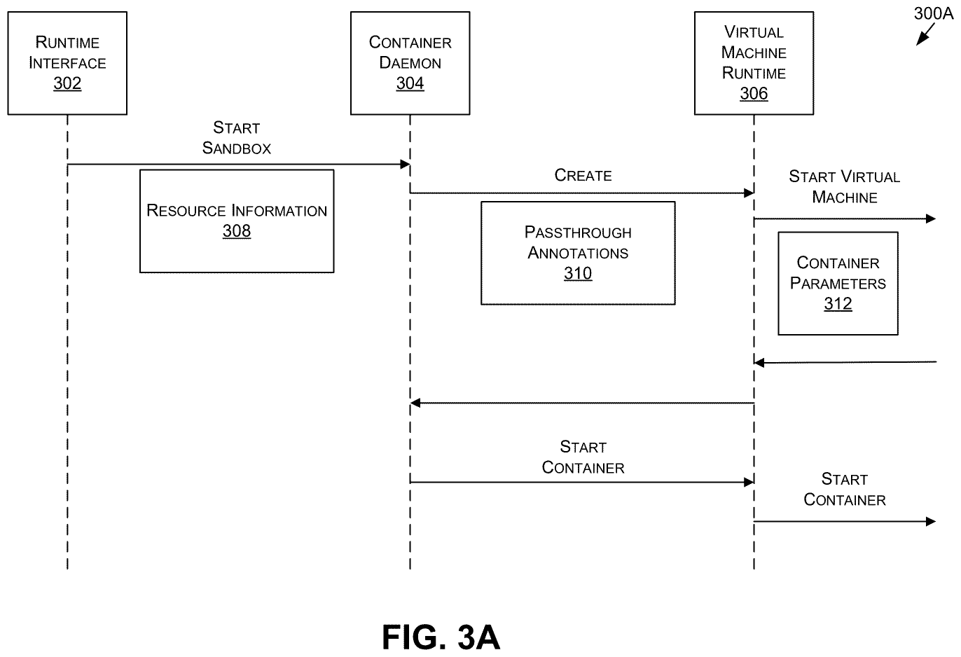

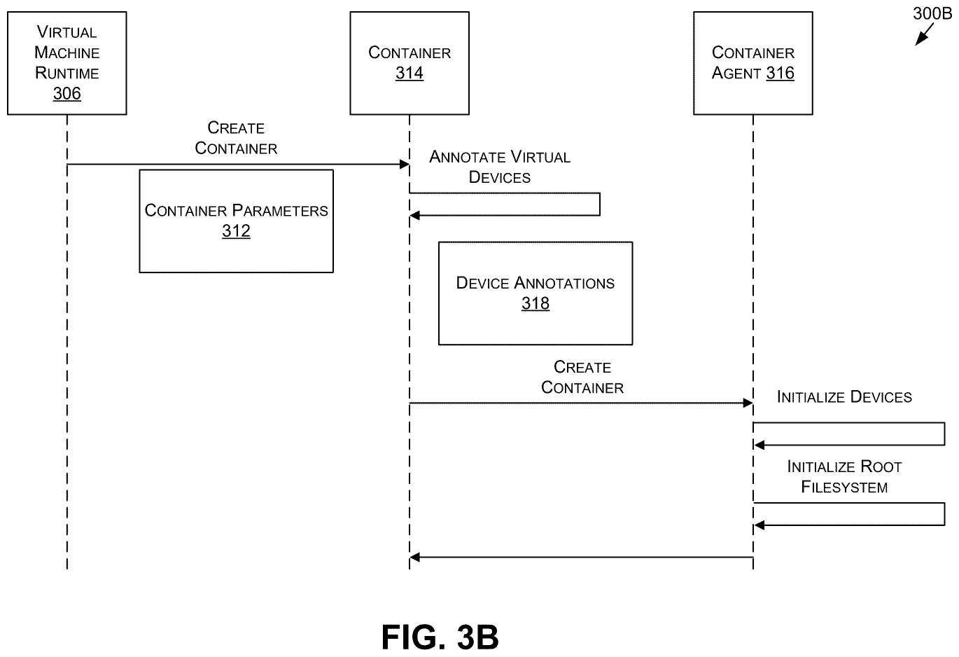

The container-device interface 115 and configuration settings 114 can be or include one or more data structures, files, or other data that facilitate initialization of containers via the container runtime 112, including the mapping of virtual devices (e.g., VFIO devices) within the virtual machine 110 to corresponding containers. In some implementations, the container-device interface 115 can associate specific virtual devices (e.g., GPUs, etc.) from the replicated host topology with corresponding containers through configuration settings 114. The container-device interface 115 can include device identifiers, such as BDF identifiers and/or VFIO device identifiers which may be enumerated via the driver stack executing within the virtual machine 110. In some implementations, the container runtime 112 can match virtual devices to containers according to specified workload requirements in the container data 126. For example, during initialization, the virtual machine initializer 104 can generate passthrough annotations (e.g., as described in connection with FIGS. 3A and 3B) that define the mapping of host physical component interfaces to virtual devices within the virtual machine 110. The passthrough annotations can include information such as device identifiers, resource allocation details, and topology specifications, among other data. The container runtime 112 can use the annotations to update the configuration settings 114 of the container-device interface 115, such that the appropriate virtual devices can be allocated to the container for executing the GPU workload 124.

In some implementations, the container runtime 112 can assign each virtual device to only one container such that device access is exclusive, thereby preventing conflicts or interference between different containers. In some implementations, the assignment of devices to containers can be performed according to the order in which BDF identifiers are enumerated. For example, devices may be assigned in the order they are discovered to enable consistent allocation of resources according to the container data 126. Furthering this example, the container runtime 112 may prioritize containers with higher resource requirements to receive devices with lower BDF addresses and/or distribute devices in a round-robin fashion to balance utilization across the system. The assignments can be tracked via the configuration settings 114 for containers initialized via the container runtime 112, as described herein.

In some implementations, the container runtime 112 can use the passthrough annotations provided by the virtual machine initializer 104 to update the configuration settings 114 of the container-device interface 115 according to one or more shared GPU configurations. For example, the passthrough annotations can specify that a particular GPU workload 124 requires access to a virtual GPU (vGPU) or a Multi-Instance GPU (MIG) partition, which can be mapped to one or more corresponding virtual devices within the virtual machine 110. The container runtime 112 can then update the configuration settings 114 to associate the identified virtual device with the container, enabling the container to execute the GPU workload 124 using the corresponding resource. If the container data 126 specifies additional requirements, such as peer-to-peer communication between PCIe devices or specific memory allocation settings, the container runtime 112 can update the configuration settings 114 for the container to reflect a corresponding mapping of virtual devices to the container that satisfies such specifications.

Prior to executing any GPU workload(s) 124 with a corresponding container, the virtual machine 110 can undergo an attestation process which verifies that the virtual machine 110 is executing in a confidential computing environment and/or that the configuration of the virtual machine 110 (e.g., the devices/configuration thereof) match an expected configuration. In some implementations, the attestation process (e.g., an attestation function) can be performed in part using the trusted execution environment manager 116. For example, the trusted execution environment manager 116 may track how data for the virtual machine is written to memory of the data processing system 102 to generate an attestation message. In some implementations, this can include generating one or more hashes or other representative information of the unencrypted data for the virtual machine 110 during initialization. For example, the data of the initial state of the virtual machine can be hashed or otherwise processed to generate a fingerprint of the virtual machine 110, which may include data corresponding to the container runtime 112, configuration settings 114, and the container-device interface 115.

The trusted execution environment manager 116 can generate a digital signature for the fingerprint. For example, the trusted execution environment manager 116 can sign the fingerprint using a private cryptographic key stored within one or more registers of the processor(s) of the data processing system 102, which may correspond to the TEE of the virtual machine 110. The private key can enable the trusted execution environment manager 116 to generate a digital signature using a cryptographic algorithm, such as the Elliptic Curve Digital Signature Algorithm (ECDSA), which can be used to authenticate the fingerprint. The trusted execution environment manager 116 can generate an attestation message 120 to transmit to the verification system 118 by combining the fingerprint and the digital signature. In some implementations, additional metadata such as information relating to the GPU workload 124, the data processing system 102, or any other information described herein may be included in the attestation message 120.

The trusted execution environment manager 116 can transmit the attestation message 120 to the verification system 118, for example, using a secure communication channel, such as a secure socket layer (SSL) connection, a transport layer security (TLS) connection, or any other type of encrypted network connection. The verification system 118 can be a computing system that can store data for verifying signatures and information corresponding to the data processing system 102. The verification system 118 may be included as part of a cloud computing system, a remote distributed computing system, one or more servers, or any other type of computing system. The verification system 118 can receive and can process the attestation message 120 and can verify the integrity and authenticity of the fingerprint and/or the digital signature.

To verify the fingerprint, the verification system 118 can compare the hash and/or fingerprint state of the virtual machine 110 (e.g., the initial state captured during initialization) to an expected hash and/or state. For example, the verification system 118 may store sets of state information (e.g., hashes, fingerprints, etc.) corresponding to different computing environments. The expected state information can represent an initial state of the virtual machine prior to executing any GPU workloads 124. For example, the expected state information may be a hash of one or more memory regions storing an expected kernel, expected drivers, and/or expected device configurations (e.g., GPU configurations, etc.). In some implementations, the expected state information may represent data corresponding to the container runtime 112, the configuration settings 114, and/or the container-device interface 115. One or more fingerprints of the virtual machine 110 can be generated at any time via the trusted execution environment manager 116, transmitted to the verification system 118, and subsequently compared to corresponding expected state information.

To verify the digital signature of the attestation message 120, the verification system 118 can use a corresponding public key to validate the signature. The public key can correspond to the private key used to generate the digital signature for the fingerprint. To do so, the verification system 118 can execute one or more cryptographic operations (e.g., the ECDSA algorithm, hash-based message authentication, etc.) to confirm that the digital signature was generated using the corresponding private key and that the fingerprint has not been altered during transmission. If the verification system 118 successfully validates the digital signature and the fingerprint, the verification system 118 can send a verification message 122 back to the trusted execution environment manager 116 that indicates the execution environment is executing in a proper TEE and includes an expected configuration, allowing the virtual machine 110 to proceed with executing the GPU workload 124. In some implementations, the verification message 122 can include one or more authentication tokens or keys that can be used by the container runtime 112 and/or the trusted execution environment manager 116 to decrypt or decode one or more portions of the GPU workload 124 and/or container data 126 for execution.

If the verification system 118 cannot successfully validate the digital signature and/or the fingerprint, the verification system 118 can transmit an error message to the trusted execution environment manager 116. In some implementations, the verification system 118 can be the same system that can provide the GPU workload 124 and/or the container data 126 (or portions thereof) to the trusted execution environment manager 116. In some implementations, the verification system 118 can be a different computing system. In some implementations, the verification system 118 can transmit the verification message 122 to any computing system attempting to execute the GPU workload 124, such that the computing system can determine that the configuration of the data processing system is operating in an expected TEE environment and provide any encrypted data of the GPU workload 124 to the data processing system 102 for execution.

The container runtime 112 can execute the corresponding GPU workload 124 in one or more containers according to the configuration settings 114 of the container-device interface 115. To initialize a container, the container runtime 112 can parse the configuration settings 114, which may include parameters such as resource allocation, device mappings, and execution requirements. The container runtime 112 can use the configuration settings 114 to allocate resources such as memory, processor(s) cores, GPUs, and/or other resources for the container. The container-device interface 115 can facilitate the identification and enumeration of virtual devices, such as virtual GPUs or other virtual hardware components, which may be used by the container to execute the GPU workload 124. For example, the container runtime 112 can map virtual devices (e.g., VFIO devices) to the container using the container-device interface 115. Data can be transferred into the container by loading one or more portions the GPU workload 124 and/or container data 126 into one or more allocated resources (e.g., memory of the container, storage etc.) of the container.

In some implementations, the container runtime 112 can decrypt and/or decode data of the GPU workload 124 and/or the container data 126 for execution within the container. For example, the container runtime 112 can use one or more decryption keys or tokens provided by the trusted execution environment manager 116 to decrypt executable instructions and/or data (e.g., binary files, data to be processed, machine-learning models, any other container data, etc.) of the GPU workload 124 and/or container data 126. In some implementations, the decryption keys can be received in one or more verification messages 122 from the verification system 118, such that the GPU workload 124 can be decrypted for execution only when the virtual machine 110 has been properly attested. Once decrypted, the GPU workload 124 can be executed within the container using the mapped virtual devices (e.g., GPUs, network interfaces, etc.) to perform the computations of the GPU workload 124. The container runtime 112 can manage the lifecycle of the container, including starting, stopping, and monitoring the execution of the GPU workload 124 according to inputs to the data processing system 102. For example, the data processing system 102 may receive requests to start, stop, and/or modify the container(s) within the virtual machine 110 (e.g., from an operator of the data processing system 102, from one or more external computing devices, etc.).

In some implementations, the container runtime 112 can execute multiple containers within the virtual machine 110, such that one or more of the containers can be initialized to access a respective hardware device (e.g., GPU, network interface, etc.) of the data processing system 102 according to the configuration settings 114 and/or container-device interface 115. For example, the container data 126 of the GPU workload 124 may specify how the container runtime 112 is to schedule container tasks and manage resource allocation for multiple containers, which may each execute a portion of one or more corresponding GPU workloads 124. For example, the container runtime 112 can initialize a first container to execute a compute-intensive task requiring access to a virtual GPU (vGPU), while initializing a second container to execute a second data processing task requiring access to a virtual network interface. Initializing the multiple containers can include parsing the configuration settings 114 to identify the specific hardware devices or virtual resources to be assigned to each container. For example, the container runtime 112 can use the configuration settings 114 of the corresponding container-device interface 115 to map the virtual devices (e.g., VFIO devices) corresponding to the physical hardware devices of the data processing system 102 to the respective containers, as described herein.

In some implementations, additional attestation processes can be performed with respect to the container(s) (e.g., the GPU workload 124 and/or container data 126 thereof) prior to execution. For example, the container runtime 112 can verify the authenticity of the GPU workloads 124 before initializing and/or executing the GPU workloads 124 within one or more containers according to the techniques described herein. In some implementations, the container runtime 112 can utilize various example approaches to verify the authenticity of the GPU workload 124. In one example, the container runtime 112 can use cryptographic hash functions to generate a hash of the GPU workload 124 and compare it to a stored and/or expected hash value. In another example, the container runtime 112 can use digital signatures to authenticate the GPU workload 124, where the signature is generated using a private key (e.g., by a provider of the GPU workload 124) and verified using a corresponding public key (e.g., included as part of the virtual machine 110 image and/or file system, etc.). In some implementations, the container runtime 112 can implement a combination of verification approaches to verify the authenticity of the GPU workload 124 and/or data thereof. In some implementations, a digital signature of the GPU workload 124 may be verified via communications with one or more verification systems 118, using similar approaches to those described herein. If the GPU workload 124 is verified, the container runtime 112 can proceed to execute the GPU workload 124 within the container according to the techniques described herein. If the GPU workload 124 cannot be verified, the container(s) may be de-initialized and/or the virtual machine 110 may be de-activated, and an error message can be generated (e.g., in a log file, as an output) that indicates the GPU workload 124 could not be verified.

Executing containers according to these techniques enables the execution of GPU workloads 124 within confidential computing environments without making modifications to the GPU workloads 124 themselves. Unlike conventional containers, which cannot implement GPUs or other specialized hardware within confidential containers, the techniques described herein enable selective topology replication of the host platform within virtualized containers that are attested as executing within confidential computing environments. This approach enables containers that could only otherwise be executed in unprotected environments to be “lifted and shifted” to this environment, such that the containers can automatically be executed within confidential containers having requisite hardware resources.

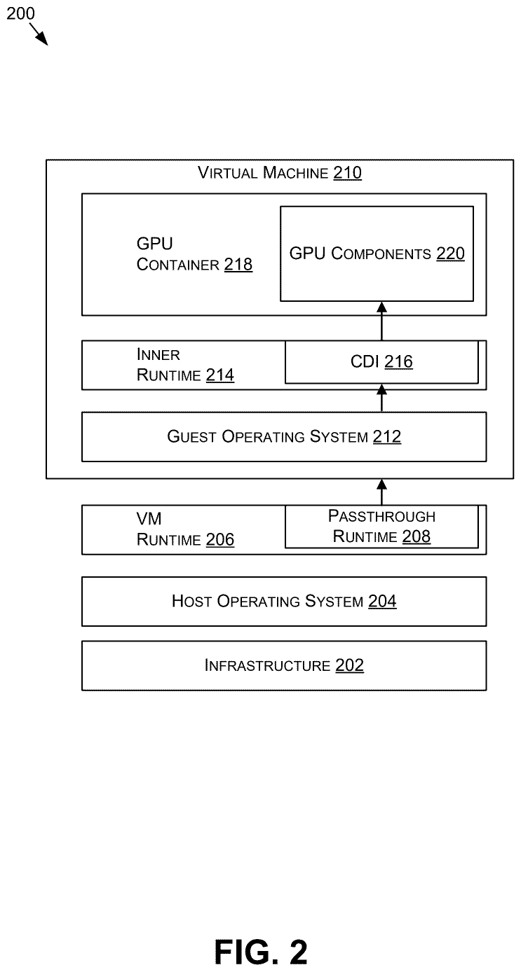

FIG. 2 depicts a block diagram 200 showing an example hierarchy of runtimes and virtual machines according to the techniques described herein, in accordance with some embodiments of the present disclosure. The diagram 200 is shown as including a hardware infrastructure 202, a host operating system 204, a VM runtime 206, and a virtual machine 210. The VM runtime 206 is shown as including a passthrough runtime 208. The virtual machine 210 is shown as including a guest operating system 212, an inner runtime 214, and a GPU container 218. The inner runtime 214 is shown as including a component-device interface (CDI) 216. The GPU container 218 is shown as including one or more GPU components 220.

The diagram 200 is shown as including at least one hardware infrastructure 202. The hardware infrastructure 202 may include any of the components of the host environment, such as the hardware of the data processing system 102 of FIG. 1. The hardware infrastructure 202 can execute the host operating system 204 and may be used to carry out various operations described herein. The hardware infrastructure 202 may include processors that implement confidential computing techniques. In some implementations, the hardware infrastructure 202 can include hardware such as processor cores, memory, or storage to support the execution of the host operating system 204. The hardware infrastructure 202 may include one or more GPUs, network interfaces, or other PCIe devices.

The diagram 200 is shown as including at least one host operating system 204. The host operating system 204 can manage hardware resources, such as processor cores, memory, storage, and input/output devices, to enable execution of processes and applications. The host operating system 204 can schedule processes, allocate resources, and enforce access control policies for hardware and software components. The host operating system 204 can interact with the VM runtime 206 to support virtualization. For example, the host operating system 204 can provide low-level hardware access for the VM runtime 206 and manage resource allocation for virtual machines executing on the hardware infrastructure 202. The host operating system 204 can execute instructions to create, configure, and terminate virtual machines 210. In some implementations, the host operating system may enumerate or otherwise identify hardware interfaces for use in connection with the techniques described herein.

The diagram 200 is shown as including at least one VM runtime 206. The VM runtime 206 can manage virtual machines 210. The VM runtime 206 can emulate hardware components, such as processor cores, memory, and storage, to enable the execution of guest operating systems within virtual machines 210. The VM runtime 206 can interact with the host operating system 204 to enable virtualization, by requesting resource allocations and managing hardware access on behalf of virtual machines 210. The VM runtime 206 to create and configure virtual machines 210, for example, by performing the various techniques described herein in connection with the data processing system 102 of FIG. 1.

The VM runtime 206 is shown as including at least one passthrough runtime 208. The passthrough runtime 208 can manage hardware access for the virtual machine 210, enabling the virtual machine 210 and components thereof to directly interact with hardware components of the hardware infrastructure 202. The passthrough runtime 208 can perform device passthrough, for example, using VFIO devices, to allow the guest operating system 212 to access hardware resources like GPUs or other PCIe devices, as described herein. For example, the passthrough runtime 208 can replicate the PCIe topology of the hardware infrastructure 202, allowing the guest operating system 212 to enumerate and utilize the virtual devices as if they were physical components within the virtual machine 210, as described herein.

The diagram 200 is shown as including at least one virtual machine 210. The virtual machine 210 can be similar to, and include any of the structure or functionality of, the virtual machine 210. The virtual machine 210 can be initialized with a guest operating system 212 (e.g., a Linux-based operating system, other types of operating systems, etc.). The guest operating system 212 can execute one or more driver stacks for various workloads (e.g., GPU workloads 124) to enumerate and initialize one or more physical devices (e.g., GPUs, network interfaces, etc.) provided via the passthrough runtime 208. As shown, the virtual machine 210 can execute an inner runtime 214 (which may be similar to and may perform any of the functionality of the container runtime 112), which can implement a component-device interface 216 to map specific hardware resources (e.g., GPUs, network interfaces, PCIe switches, etc.) to at least one GPU container 218.

The GPU container 218 can be a container that executes a GPU workload (e.g., the GPU workload 124), and may be initialized and/or executed according to the techniques described herein. As shown, the GPU container 218 can include the GPU components 220. The GPU components may include GPU drivers, GPU device libraries, or binaries that access GPU functionality. The GPU components 220 may be generated in part (e.g., as device nodes, etc.) using the data provided by the inner runtime 214. The GPU container 218 can execute within the virtual machine 210 to securely process any type of GPU-related workload. The GPU container 218 and/or the virtual machine 210 can be attested and verified prior to execution, as described herein. An example initialization process for the GPU container 218 is described in connection with FIGS. 3A and 3B.

Referring to FIGS. 3A and 3B, illustrated are data flow diagrams 300A and 300B, respectively, illustrating an example initialization process for one or more containers implementing the techniques described herein. As shown in FIG. 3A, a runtime interface 302, which can be any type of interface that can interact with one or more container platforms, can generate initiate a “start sandbox” function according to a runtime configuration for. This can include providing resource information 308 to a container daemon 304, which can initialize one or more VM runtimes 306. The resource information 308 may include various information relating to the processor(s), memory, and/or identifiers of physical devices (e.g., GPUs, network interfaces, PCIe switches, etc.).

In this example, the container daemon 304 can initiate creation of sandboxes (e.g., virtual machines) and/or containers via corresponding runtimes. In this example, upon receiving the start sandbox command and the resource information 308, the container daemon 304 can generate a “create” command (e.g., via a corresponding API) for the virtual machine runtime 306, including a set of passthrough annotations 310 generated using the resource information 308. The passthrough annotations 310 can include, but are not limited to, processor period information (e.g., timing for virtual machine), processor quota information, processor sharing information, memory configuration information (e.g., an allocated amount of memory), and/or indications of one or more physical devices (e.g., GPUs, network interfaces, PCIe switches, etc.). In some implementations, the passthrough annotations 310 can include information relating to the BDF identifiers for one or more of the physical devices, along with corresponding virtual device nodes (e.g., VFIO nodes, etc.).

The virtual machine runtime 306 can implement any of the functionality described herein to execute one or more virtual machines. As shown, the virtual machine runtime 306 can initiate one or more virtual machines using corresponding container parameters 312 for an intended GPU workload. The container parameters may include container-device interface metadata, indications of the type(s) of physical devices that are to pass through the virtual machine for the corresponding workload, and identifiers of the physical devices that are to pass through the virtual machine for the corresponding workload. The virtual machine runtime 306 can initialize a virtual machine including the container parameters 312 as described herein. Upon initialization, the virtual machine runtime 306 can provide a signal to the container daemon 304, which can initiate a start container function, as shown.

Referring to FIG. 3B, illustrated is the diagram 300B, showing how the virtual machine runtime 306 can initialize one or more containers 314 within a virtual machine (e.g., the virtual machine 110 of FIG. 1, the virtual machine 210 of FIG. 2, etc.). To do so, the virtual machine runtime 306 can initiate one or more “create container” commands, including the container parameters 312 (or a subset thereof). The container 314 can be initialized using, for example, a driver stack for the one or more physical components identified in the container parameters 312. In doing so, the container 314 can generate one or more device annotations 318, which include annotations of specific physical component identifiers for each of the virtual devices. The container 314 can execute a container agent 316, which can initialize the virtual devices (e.g., by accessing a container-device interface specification for the corresponding device, etc.) and initializing the root filesystem of the container 314. Once initialized, the container 314 may execute one or more container workloads using the virtual devices.

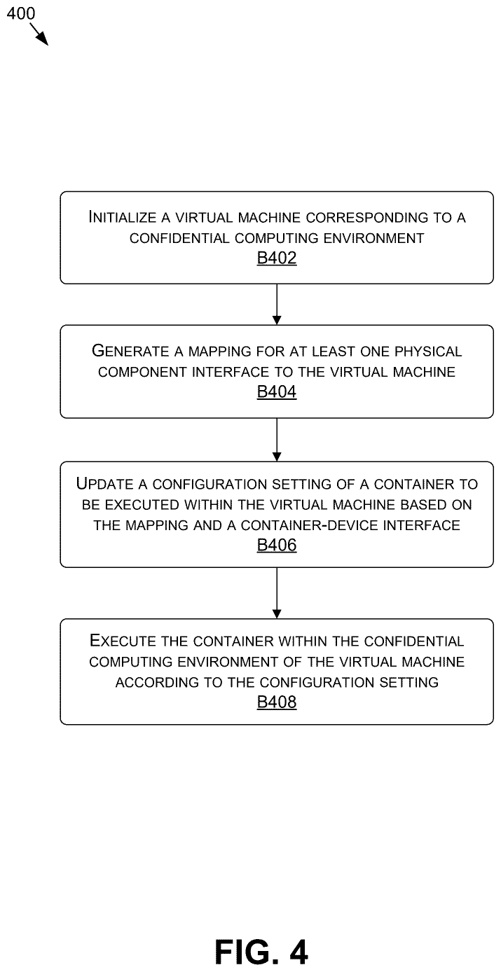

Now referring to FIG. 4, each block of method 400, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

FIG. 4 is a flow diagram showing a method 400 for managing confidential containers implementing GPU workloads, in accordance with some embodiments of the present disclosure. The method 400, at block B402, can include initializing a virtual machine (e.g., virtual machine 110, virtual machine 210, etc.) corresponding to a confidential computing environment. Initializing the virtual machine may include performing any of the operations described in connection with the virtual machine initializer 104 and/or the trusted execution environment manager 116 of FIG. 1. In some implementations, initializing the virtual machine can include allocating memory, processor time, and/or other resources to the virtual machine. In some implementations, initializing the virtual machine can include initializing a guest operating system within the virtual machine. The virtual machine can be a hypervisor, or any other type of lightweight virtual machine.

The method 400, at block B404, can include generating a mapping for at least one physical component interface to the virtual machine. The mapping process can involve performing any of the operations described in connection with the mapping generator 106 of FIG. 1. The mapping of physical component interfaces to the virtual machine can providing passthrough data corresponding to one or more VFIO devices to the virtual machine. Mapping the physical component interfaces may include replicating a topology of one or more interfaces of the host system within the virtual machine. In some implementations, the PCIe topology of the host system can be replicated as a flat topology. In some implementations, the PCIe topology of the host system can be replicated as-is (e.g., including PCIe switches, etc.).

The method 400, at block B406, can include updating a configuration setting (e.g., the configuration setting 114) of a container to the be executed within the virtual machine based on the mapping and a container-device interface (e.g., container-device interface 115). Updating the configuration setting can include performing any of the operations described herein in connection with the container runtime 112. In some implementations, the configuration setting can be updated according to one or more identifiers of the virtual devices mapped to the virtual machine. For example, in some implementations, a container can be allocated for a GPU workload (e.g., a GPU workload 124), and the configuration setting can be updated to assign a GPU (represented as a virtual device) to the container. In such implementations, the GPU can be assigned from a list of devices enumerated via a corresponding BDF identifier, as described herein.

The method 400, at block B408, can include executing the container within the confidential computing environment of the virtual machine according to the configuration setting. In some implementations, the container can be used to execute the GPU workload upon performing an attestation function to verify the authenticity of the execution environment and/or the GPU workload. To do so, an attestation message can be generated (e.g., with a fingerprint encoding an initial state of the virtual machine and/or container) that includes a digital signature, which can be transmitted to a verification system (e.g., a verification system 118), as described herein. Executing the container can be include executing the GPU workload, which may include encrypted machine-learning models, data, or other confidential information. In some implementations, the GPU workload can be decrypted upon verifying that the execution environment is operating within a confidential computing environment.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more small language models (SLMs), one or more vision language models (VLMs), and one or more multimodal language models (MMLMs), systems for performing light transport simulation, systems for performing collaborative content creation for 3D assets, systems implemented at least partially using cloud computing resources, and/or other types of systems.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
initialize a virtual machine corresponding to a confidential computing environment;
generate a mapping for at least one physical component interface to the virtual machine;
update at least one configuration setting of a container to be executed within the virtual machine based at least on the mapping and a container-device interface (CDI); and
execute the container within the confidential computing environment of the virtual machine according to the at least one configuration setting.

2. The one or more processors of claim 1, wherein the physical component interface is a Peripheral Component Interconnect Express (PCIe) interface.

3. The one or more processors of claim 1, wherein the one or more circuits are to initialize at least one virtual function input/output (VFIO) device within the virtual machine corresponding to the physical component interface.

4. The one or more processors of claim 1, wherein the one or more circuits are to:
initiate a container runtime within the virtual machine to update the at least one configuration setting; and
execute the container using the container runtime.

5. The one or more processors of claim 1, wherein the one or more circuits are to:
identify a plurality of graphics processing units (GPUs) having a plurality of identifiers; and
update the at least one configuration setting based on the plurality of GPUs.

6. The one or more processors of claim 1, wherein the one or more circuits are to:
determine, using an attestation function, that the virtual machine is operating within the confidential computing environment; and
execute the container responsive to determining that the virtual machine is operating within the confidential computing environment.

7. The one or more processors of claim 6, wherein the one or more circuits are to:
encrypt at least one region of memory corresponding to the virtual machine;
generate, using the attestation function, an attestation message for the virtual machine; and
transmit the attestation message to at least one verification system.

8. The one or more processors of claim 1, wherein the container is one of a plurality of containers, and wherein the one or more processors are to:
execute the plurality of containers each accessing a respective hardware device of a plurality of hardware devices according to the CDI.

9. The one or more processors of claim 1, wherein the one or more circuits are to:
initialize at least one graphics processing unit (GPU) coupled to the at least one physical component interface using a driver stack within the virtual machine.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a small language model (SLM);
a system for performing generative AI operations using a video language model (VLM);
a system for generating synthetic data;
a system incorporating one or more virtual machines (VMs);
a system implemented at least partially in a data center; or
a system implemented at least partially using cloud computing resources.

11. A system, comprising:
one or more processors to:
generate, during initialization of a virtual machine, a value representative of a state of the virtual machine;
determine, using the value, that the virtual machine is executing within a confidential computing environment;
in response to determining that the virtual machine is executing within the confidential computing environment, update at least one configuration setting of a container to be executed within the virtual machine based at least on a container-device interface (CDI); and
execute the container within the confidential computing environment of the virtual machine according to the at least one configuration setting.

12. The system of claim 11, wherein the one or more processors are to:
initialize the virtual machine using a confidential computing flag of the one or more processors.

13. The system of claim 11, wherein the one or more processors are to:
encrypt at least one region of memory corresponding to the virtual machine; and
generate an attestation message based at least on the encryption of the at least one region of memory.

14. The system of claim 13, wherein the one or more processors are to:
transmit the attestation message to a verification system; and
determine that the virtual machine is executing within the confidential computing environment based at least on receiving a verification message from the verification system in response to the attestation message.

15. The system of claim 11, wherein the one or more processors are to:
generate a mapping for at least one physical component interface to the virtual machine; and
update the at least one configuration setting of the container based at least on the mapping.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a small language model (SLM);
a system for performing generative AI operations using a video language model (VLM);
a system for generating synthetic data;
a system incorporating one or more virtual machines (VMs);
a system implemented at least partially in a data center; or
a system implemented at least partially using cloud computing resources.

17. A method, comprising:
initializing, using one or more processors, a virtual machine corresponding to a confidential computing environment;
generating, using the one or more processors, a mapping for at least one physical component interface to the virtual machine;
updating, using the one or more processors, at least one configuration setting of a container to be executed within the virtual machine based on the mapping and a container-device interface (CDI); and
executing, using the one or more processors, the container within the confidential computing environment of the virtual machine according to the at least one configuration setting.

18. The method of claim 17, wherein the physical component interface is a Peripheral Component Interconnect Express (PCIe) interface.

19. The method of claim 17, further comprising initializing, using the one or more processors, at least one virtual function input/output (VFIO) device within the virtual machine corresponding to the physical component interface.

20. The method of claim 17, further comprising:
initiating, using the one or more processors, a container runtime within the virtual machine to update the at least one configuration setting; and
executing, using the one or more processors, the container using the container runtime.
